(19) United States
(12) Patent Application Publication
(10) Pub. No.: US 2010/0082530 A1
(43) Pub. Date: Apr. 1, 2010

(54) LOG MANAGEMENT SERVER

(75) Inventor: Atsushi MIYAMOTO, Tokyo (JP)

Correspondence Address: MATTINGLY & MALUR, P.C., 1800 DIAGONAL ROAD, SUITE 370, ALEXANDRIA, VA, 22314, US

(73) Assignee: HITACHI SOFTWARE ENGINEERING CO., LTD., Tokyo (JP)

(21) Appl. No.: 12/435,669

(22) Filed: May 5, 2009

(30) Foreign Application Priority Data
Sep. 19, 2008 (JP) 2008-240338

(51) Int. Cl. G06F 17/30

(52) U.S. Cl. 707/609; 707/E17.005

(57) ABSTRACT

A log management server enables an administrator to manage a log with a lighter load without compelling a client to bear any load in a log management processing. The log management server receives a log from a client 11 and stores the log in a log management database 13. Among pieces of log data A to C recorded in a common log and each formed by data specifying an event, the log management server detects a piece of log data A, B having contents on record identical to another piece of log data as redundant log data, removes the contents on record of the redundant log data other than a piece of log data representative of the redundant log data and stores the log manageably in the log management database.

### BACKGROUND OF THE INVENTION

1. Field of the Invention

The present invention relates to a log management server capable of managing a log transferred from a client.

2. Description of the related art:

In recent years, from the viewpoint of security or the like, it has become increasingly important to manage a log having on record a series of events—access to contents and the like. A processing for managing the log (below called log management processing) is executed at a predetermined time, for example, at a regular interval or the like. FIG. 4 is a block diagram showing a log management processing executed by a log server according to a prior art.

Conventionally, as shown in FIG. 4, a log server 12 receives a log including log data A to C transferred from a client 11 and stores it directly in a log management database 13 to thereby store the pieces of log data A and B which are redundant (below called redundant log data) among pieces of data such as contents corresponding to events inside of the log directly in the log management database 13.

If necessary, an administrator checks and manages the log stored in the log management database 13, and for example, sets “distinct” in an SQL select statement of specified redundant log data to thereby prevent the redundant log data from being displayed. As a matter of course, the administrator manages it manually and thereby takes a heavy work load and a long processing time in a specified case.

A prior art of lighting the management load or the like is known (e.g., Japanese Patent Laid-Open Publication No. 2007-079902). In the prior art according to Japanese Patent Laid-Open Publication No. 2007-079902, a client is an image processor which decides by the hash value of an image whether the image is already registered and avoids storing it redundantly, thereby lighting the processing load on a log server.

However, a conventional log management server allows a client to manage a log, and thereby, the client takes a heavier processing load and cannot occasionally execute the primary processing. In addition, it targets image data having a large amount of data and thereby is ineffective for an access log to contents other than image data. Besides, a file tends to have a smaller data amount than an image, and hence, frequently need no hash value for retrieval.

### DISCLOSURE OF THE INVENTION

In view of the present situation, it is an object of the present invention to provide a log management server enabling an administrator to manage a log with a lighter load without compelling a client to bear any load in a log management processing.

In order to solve the problems, the present invention offers the following configurations.

A log management server according to claim 1 of the present invention receives a log from a client and stores the log in a log management database, in which among pieces of log data recorded in a common log and each formed by data specifying an event, a piece of log data having contents on record identical to another piece of log data is detected as redundant log data, and after the contents on record of the redundant log data other than a piece of log data representative of the redundant log data are removed, the log is stored manageably in the log management database.

The log management server according to claim 1 of the present invention receives a log from a client and stores the log in a log management database, in which among pieces of log data recorded in a common log and each formed by data specifying an event, a piece of log data having contents on record identical to another piece of log data is detected as redundant log data, and after the contents on record of the redundant log data other than a piece of log data representative of the redundant log data are removed, the log is stored manageably in the log management database.

### BRIEF DESCRIPTION OF THE DRAWINGS

FIG. 1 is a block diagram showing a flow of log data.

FIG. 2 is a block diagram showing a log management processing executed by a log management server according to the present invention.

FIG. 3 is a flow chart showing the log management processing according to the present invention.

FIG. 4 is a block diagram showing a log management processing executed by a log server according to a prior art.

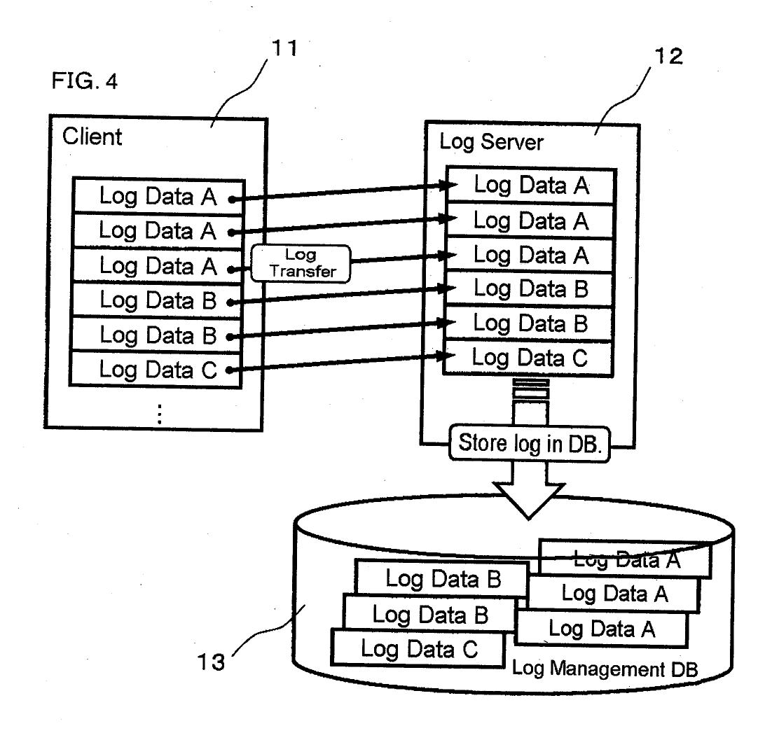

### DETAILED DESCRIPTION OF THE INVENTION

An embodiment of the present invention will be below described with reference to the drawings showing a practical example.

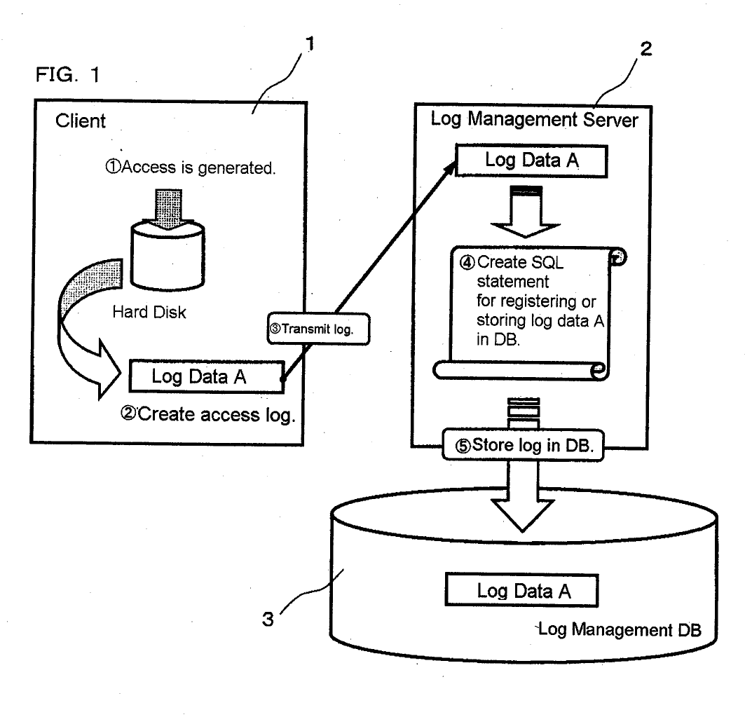

FIG. 1 is a block diagram showing a flow of log data. Upon receiving an access, a client 1 creates log data having, on record, data specifying events such as the access and a processing during the access, and in response to an access (below called log management access) for managing a log from a log management server 2, transmits a corresponding log to the log management server 2. The transmitted log includes log data accumulated between a log management access immediately before and the log management access this time.

The log management server 2 creates an SQL statement corresponding to log data inside of the log received from the client 1 and stores the log data in a log management database (below called log management DB) 3. Herein, the log data is not a piece of redundant log data having an event identical to another piece of log data on record, and the SQL statement is a command given in a so-called structural query language already known which is used for registering or storing data in a relevant database and checking or editing the data inside of the database.

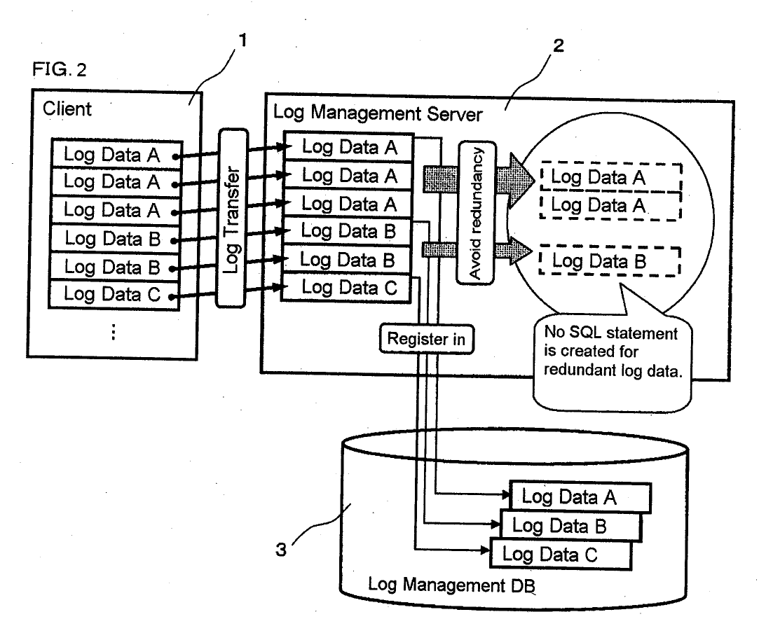

FIG. 2 is a block diagram showing a log management processing executed by a log management server according to the present invention. The log management server creates an SQL statement in a processing for managing a log (below called log management processing) after detecting redundant log data. Apart from a piece of log data (below called representative log data) representative of the detected redundant log data, the redundant log data is subjected to a redundancy avoidance processing of creating no SQL statement for registering or storing the redundant contents. In short, the contents of the log data subjected to the redundancy avoidance processing are not supposed to be registered or stored.

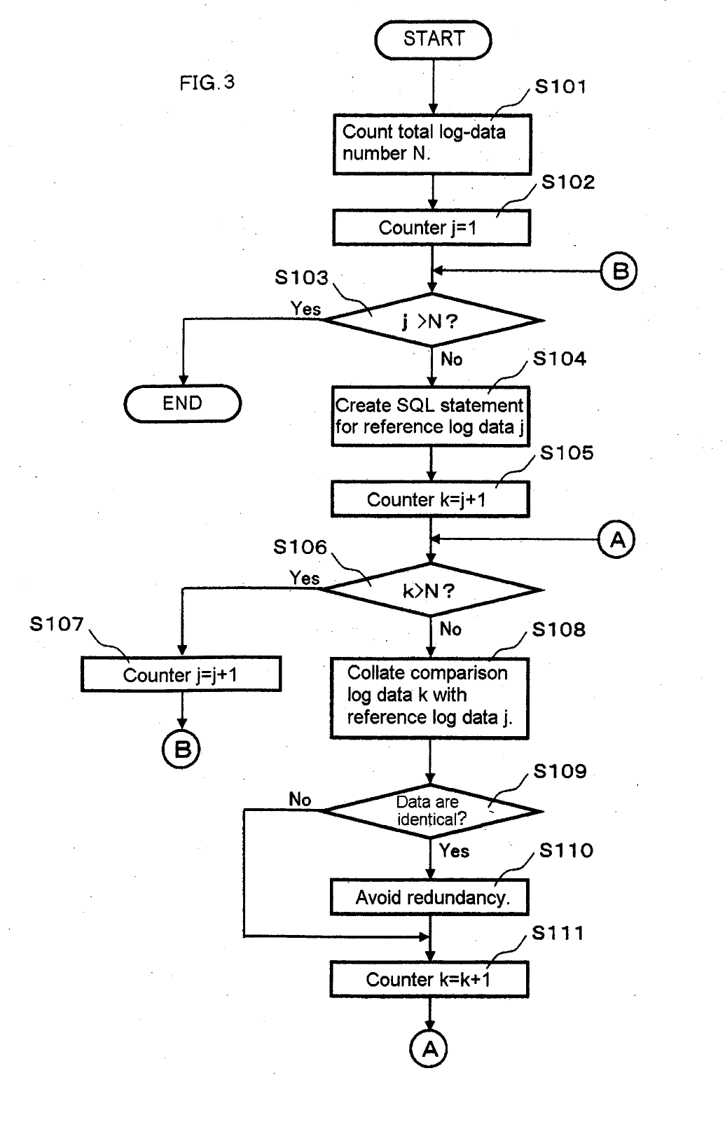

FIG. 3 is a flow chart showing the log management processing according to the present invention. In the log management processing, first, the log management server 2 counts a total number N of pieces of log data to be processed (S101), and sequentially, initializes a counter j for reference log data as a collation original to 1 (S102). The reference log data is representative log data if it corresponds to redundant log data. Next, the log management server 2 decides whether the counter j is beyond the total number N (S103), and ends the processing if deciding that it is beyond the total number N.

If deciding that the counter j is not beyond the total number N at the step S103, the log management server 2 creates an SQL statement for registering or storing reference log data j (S104), thereby making it possible to check or manage the reference log data j using the SQL statement. Sequentially, the log management server 2 initializes a counter k for a comparison log data to be collated with the reference log data j to j+1 (S105).

Next, the log management server 2 decides whether the counter k is beyond the total number N (S106). If deciding that it is beyond the total number N, then it gives an increment of 1 to the counter j for the reference log data (S107), returns to the step S103 and repeats the subsequent processing.

If deciding that the counter k is not beyond the total number N at the step S106, the log management server 2 extracts comparison log data k and collates it with the reference log data j (S108 and S109), or specifically in the collation, makes a comparison and a decision on whether the comparison log data k is identical to the reference log data j.

Next, if deciding that the comparison log data k is identical to the reference log data j at the step S109, the log management server 2 executes the above redundancy avoidance processing for the comparison log data k (S110). If it undergoes the redundancy avoidance processing, the redundant contents thereof are not registered or stored, thereby saving a storage region of the log management DB 3.

If deciding that the comparison log data k is not identical to the reference log data j at the step S109 or if executing the redundancy avoidance processing in the step S110, then the log management server 2 gives an increment of 1 to the counter k for the comparison log data (S111), returns to the step S106 and repeats the subsequent processing. Through the above processing, an SQL statement is created for not only a single piece of log data but also a piece of representative log data in the step S104, and the remaining redundant log data is subjected to the redundancy avoidance processing in the step S110.

The log management server according to the present invention can be realized as a telecommunication device, a program installed therein or the like, and employed by an electrical-appliance or software manufacturer or the like, thereby making those products more useful.

What is claimed is:

1. A log management server which receives a log from a client and stores the log in a log management database,
wherein among pieces of log data recorded in a common log and each formed by data specifying an event, a piece of log data having contents on record identical to another piece of log data is detected as redundant log data, and after the contents on record of the redundant log data other than a piece of log data representative of the redundant log data are removed, the log is stored manageably in the log management database.
